(19) United States
(12) Patent Application Publication
(10) Pub. No.: US 2011/0047790 A1
(43) Pub. Date: Mar. 3, 2011

(54) TWO-IN-ONE CABLE-CRIMPING DEVICE FOR COMMUNICATION CONNECTORS

(75) Inventors: John Peng, Taipei County (TW); Alex Chen, Taipei County (TW)

(73) Assignees: DAN-CHIEF ENTERPRISE CO., LTD., Taipei County (TW); TOOLMART INDUSTRIAL CO., LTD., Taipei County (TW)

(21) Appl. No.: 12/862,945

(22) Filed: Aug. 25, 2010

(30) Foreign Application Priority Data
Sep. 3, 2009 (TW) 098129666

(51) Int. Cl. H01R 43/042

(52) U.S. Cl. 29/751

(57) ABSTRACT

Disclosed is a two-in-one cable-crimping device for communication connectors, and this device includes a first handle pivoted with a second handle. A lever gadget, composed of the first and the second levers, is connected to the first handle. The first lever and the second lever respectively actuates the first cable-crimping gadget and the second cable-crimping gadget which are configured at the first handle, so as to provide the cable-crimping operation on two connectors with the same specifications. Furthermore, the component of the cable-crimping gadget can be replaced according to the specifications of the connectors. The efficiency on cable-crimping operation can be increased, the cable-crimping operation can be selected based on the user's demand, and the cable-crimping operation of the present invention has convenient practicability.

### FIELD OF THE INVENTION

The present invention relates to a cable-crimping device for providing two communication connectors with different specifications being crimped by the corresponding cables.

### BACKGROUND OF THE INVENTION

At present, for conducting the signals among different electronic devices, the use of signal cables are necessary. The terminals of the signal cables must have the communication connector to plug into the connector of the electronic device. Further, since the communication connectors used by currently various communication apparatuses or electronic devices have their particular specifications, the hand tool for the cable-crimping devices must be utilized to crimp the signal cable with specific specifications into the connector with corresponding specifications, thereby the signal cable is plugged into the electronic device.

Currently, the cable-crimping device is disclosed to connect the signal cable to the connector. For instance, U.S. Patent Publication No 2010/0071202 A1 entitled “CABLE-CRIMPING TOOL FOR CONNECTOR” discloses a the structure including: a first handle having a connector socket and a second handle pivoted with the first handle, a pivot portion being formed between the first handle and the second handle; a slider located between the first handle and the second handle, and including the crimping and cutting element; and a connecting rod connecting the second handle and the slider. When the first and the second handles approach to each other, the connecting rod drives the slider to move the crimping and cutting element toward the connector socket so that the connector at the socket is engaged with the corresponding signal cable.

However, as to the currently rapid cable-crimping tool, the connected slider is merely driven to move due to one end of the connecting rod, and then the slider is driven to move the crimping and cutting element toward the connector socket, so as to achieve the cable-crimping operation. Therefore, the tool only provides for the connector with one kind of specification, and the usage scope is limited. The tool cannot provide for the cable-crimping operation on two connectors with different specifications. If the cable-crimping operation is performed on two connectors with different specifications, it will be accomplished by preparing two cable-crimping devices with different corresponding specifications. It is inconvenient for carrying two or more tools, and it must cost money on preparing two tools with different specifications.

Furthermore, the connector socket disposed on the first handle is fixed by using the corresponding bore between the connector socket and the first handle and then engaging with the fixing dowel. Furthermore, for achieving the engagement stability, the engagement is usually performed by “tight fit”. Therefore, the socket of the cable-crimping tool only provides for the usage of a connector with one specification. If the user desires to use the connector with other specifications, the socket must be changed. As illustrated above, the current technique exists the problems on inconvenient replacement due to the “tight fit” configuration.

It is therefore attempted by the applicant to deal with the above situation encountered in the prior art.

### SUMMARY OF THE INVENTION

The inventor designs a novel two-in-one cable-crimping device due to the problems existing in the aforementioned prior art, wherein the cable-crimping device can provide for the crimping operation on two connectors with different specifications and the cables. In addition, the crimping component at one terminal of the cable-crimping device can be replaced as another socket with other specifications on demand, so that the corresponding connector can be positioned to crimp the cables.

In accordance with a first aspect of the present invention, a two-in-one cable-crimping device for connectors is provided and includes: a pair of handles having a first handle with a first fixation portion, a central portion and a second fixation portion and a second handle with an end pivoted at the central portion; a first cable-crimping gadget configured at the first fixation portion; a second cable-crimping gadget configured at the second fixation portion; and a lever gadget configured at the second handle and having a first lever with a first terminal connected to the second handle and a second terminal connected to the first cable-crimping gadget and a second lever with a first end pivotally attached to the first lever and a second end connected to the second cable-crimping gadget. The first handle and the second handle are gripped together to simultaneously cause two cables to be crimped with the connectors respectively in the first and the second cable-crimping gadgets.

Preferably, the first cable-crimping gadget includes: a receptacle holder having a combination portion and having a chamber to insert a jack therein; a crimping and cutting element having a first portion corresponding to the receptacle holder and a second portion pivotally configured to the second terminal of the first lever; and an assembling seat disposed in the first fixation portion of the first handle and having a positioning slot engaging with the combination portion of the receptacle holder.

Preferably, the first cable-crimping gadget further includes a crimping and cutting seat having a frame for disposing the crimping and cutting element therewithin, an adjustment element and a connection rack, and the crimping and cutting element includes a slot therebeneath and is sequentially assembled with the crimping and cutting seat, the adjustment element and the connection rack.

Preferably, the frame includes: a two-piece body which has two pieces being correspondingly parallel with each other; a stopper passing through the two-piece body to engage with the slot; and two mounting elements disposed on the two-piece body to fix the crimping and cutting element and the crimping and cutting seat together.

Preferably, the connection rack includes a U-shaped frame having a bottom plate and a two-side piece body having two side pieces being correspondingly parallel with each other, the bottom plate has a tapped hole to locate therein the adjustment element, the two-side piece body has at least one passing bore thereon, the first handle further includes a first pilot groove corresponding to the at least one passing bore, and the first pilot groove, the at least one passing bore and the first lever are pivotally connected.

Preferably, the crimping and cutting seat includes two slice bodies with two free ends and a rod, the assembling set has two side walls being parallel with each other and having two hollow sliding grooves introducing the two slice bodies to be moved therewithin, the rod is passing through the two hollow sliding grooves and connected to the two free ends to move the crimping and cutting element corresponding to the receptacle carrier, and the assembling seat further includes a recess corresponding to the crimping and cutting element.

Preferably, the two-in-one cable-crimping device further includes: a positioning rod disposed at the first handle and neighboring to the second cable-crimping gadget; an offset rod; and an elastic element disposed between the positioning rod and the offset rod.

Preferably, the first handle further includes a second pilot groove and an opening, and the second cable-crimping gadget further includes: an actuation rack including a first passing bore, a second passing bore, a short groove and a junction, and being pivoted to the second lever and the second pilot groove through the first passing bore; a press plate pivoted to the junction of the actuation rack through the second passing bore; and a socket configured in the second fixation portion, corresponding to the press plate, and having a chamber disposing therein one of the connectors.

Preferably, the second cable-crimping gadget further includes a slice, the socket further includes a lateral groove, the actuation rack further includes a body with two spacers having a first outer surface and a second outer surface, the press plate is disposed on the first outer surface, and the slice is disposed on the second outer surface and movable in the lateral groove.

Preferably, each of the first fixation portion and the second fixation portion has a third passing bore to be pivoted to the respective first and the second cable-crimping gadgets.

Preferably, the connectors are the same kind of connectors, or the connectors are different kinds of connectors.

In accordance with a second aspect of the present invention, a cable-crimping device is provided and includes: a first cable-crimping gadget; a second cable-crimping gadget; a first lever having a first terminal pivotally connected to the first cable-crimping gadget and a second terminal; and a second lever having a third terminal pivotally connected to the second terminal of the first lever and a fourth terminal pivotally connected to the second cable-crimping gadget.

Preferably, the cable-crimping device further includes: a first handle having a first fixation portion, a central portion coupled to the first terminal, and a second fixation portion; and a second handle configured to cover the first lever. The first cable-crimping gadget is configured on the first fixation portion and the second cable-crimping gadget is configured on the second fixation portion.

Preferably, the first cable-crimping gadget includes: an assembling seat having a pair of grooves and disposed on the first fixation portion; a receptacle holder disposed on the assembling seat; a crimping and cutting seat having a pair of rails respectively sliding on the pair of grooves; and a crimping and cutting element configured on the crimping and cutting seat. A first connector and a cable are disposed in a space between the receptacle holder and the crimping and cutting element, and the crimping and cutting element is moved forward to the receptacle holder to press the cable into the first connector.

Preferably, the first cable-crimping gadget further includes: a connector rack having a body and two arms connected to the first lever; and an adjustment connected between the body of the connector rack and the crimping and cutting seat.

Preferably, the second cable-crimping gadget includes: a socket having a chamber and disposed on the second fixation portion; a linker having a first end being pivotally connected to the second lever and a second end; and a press plate connected between the second end of the linker and the socket, wherein a second connector and a cable are disposed in the chamber, and the press plate is moved forward to the socket to press the cable into the second connector.

Preferably, the first handle has a positioning rod, the cable-crimping device further includes an resilient element connected between the first lever and the positioning rod.

In accordance with a third aspect of the present invention, a cable-crimping device is provided and includes: a first cable-crimping gadget; a second cable-crimping gadget; and a lever gadget having at least having a first terminal being pivotally connected to the first cable-crimping gadget and a second terminal being pivotally connected to the second cable-crimping gadget.

Preferably, the cable-crimping device further includes: a first handle having a first fixation portion, a central portion, a second fixation portion and a positioning rod; a second handle having a first end pivotally connected to the central portion; and an elastic element elastically connected between the first cable-crimping gadget and the positioning rod. The lever gadget further includes a third terminal being pivotally connected to the second handle. the first cable-crimping gadget is disposed in the first fixation portion. the second cable-crimping gadget is disposed in the second fixation portion, and the first terminal is pivotally connected to the second handle.

By performing the aforementioned technical means, the first and the second cable-crimping gadgets designed in the present invention can be driven to simultaneously and individually perform the cable-crimping operation on the connectors with different specifications. Further, since the first cable-crimping gadget provides the receptacle holder for positioning the connector and the crimping and cutting element is disposed on the receptacle holder to crimp the connector, the user can conveniently and rapidly replace the receptacle holder and the crimping and cutting seat as other ones where the replaced connectors to be cable-crimped have the corresponding specifications. The rapid cable-crimping operation thus is provided and is performed for the connectors with different specifications by one tool.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 is the stereo view of the present invention.

FIG. 2 is the stereo anatomic diagram of the present invention.

FIG. 3 is the diagram showing the cable-crimping operation on different connectors in the present invention.

FIG. 4 is the sectional view of the present invention.

FIG. 5 is another sectional view of the present invention.

FIG. 6 is the other sectional view of the present invention.

FIG. 7 is the stereo view showing the cable-crimping device being retrieved in the present invention.

FIG. 8 is the stereo view showing another connector applied in the cable-crimping device of the present invention.

FIG. 9 is the sectional view showing another connector applied in the cable-crimping device of the present invention.

### DETAILED DESCRIPTION OF THE PREFERRED EMBODIMENT

The present invention will now be described more specifically with reference to the following Embodiments. It is to be noted that the following descriptions of preferred Embodiments of this invention are presented herein for purpose of illustration and description only; it is not intended to be exhaustive or to be limited to the precise form disclosed.

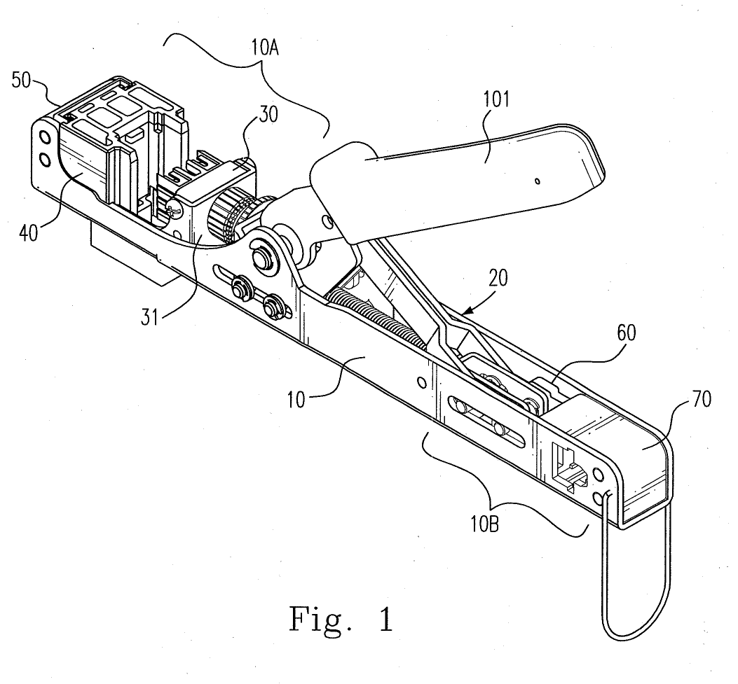

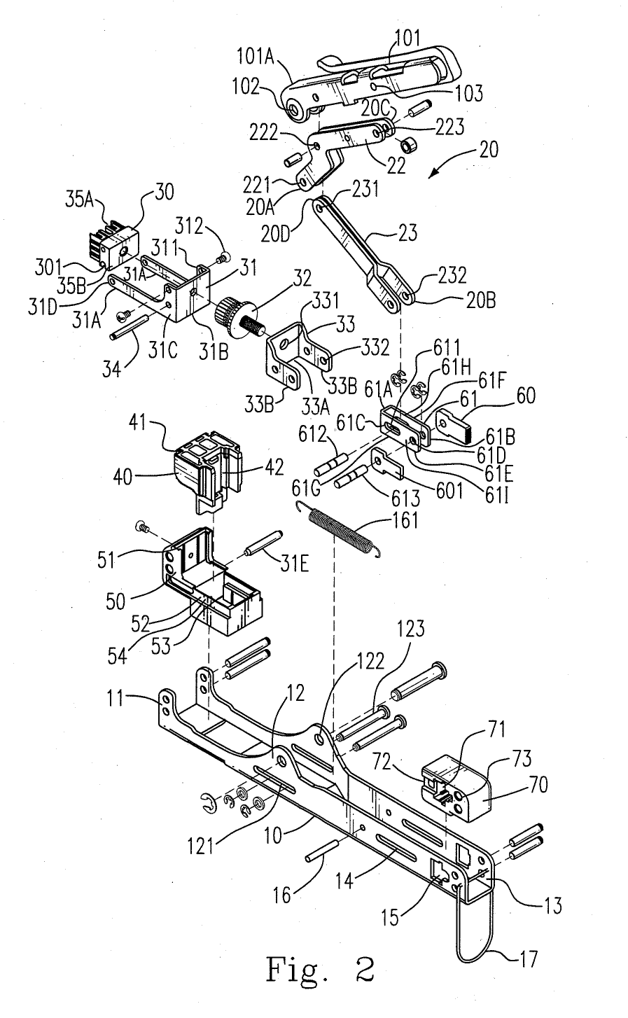

Please refer to FIGS. 1 and 2, the two-in-one cable-crimping device for communication connectors designed in the present invention includes a pair of handles (10, 101), a lever gadget 20, a first cable-crimping gadget 10A and a second cable-crimping gadget 10B.

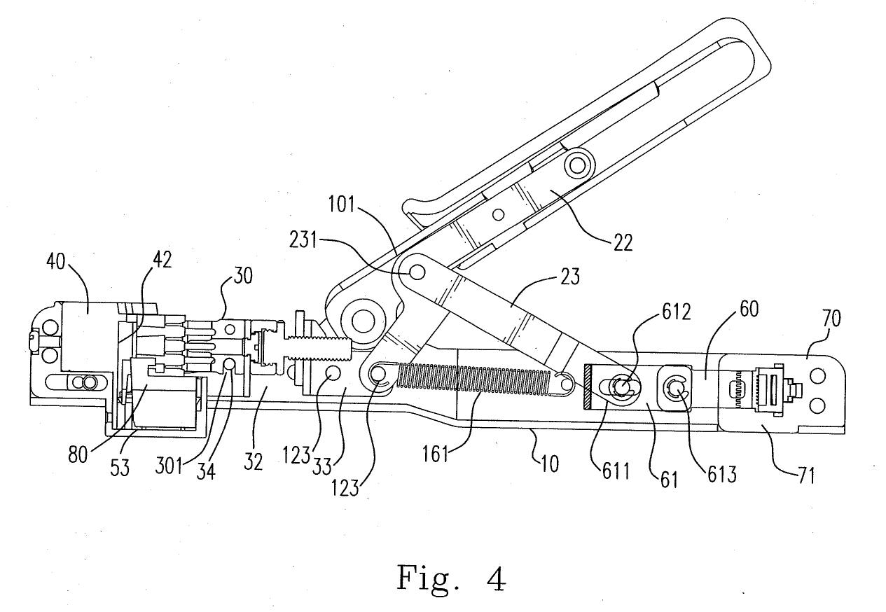

Please cooperatively refer to FIG. 4, the pair of handles (10, 101) includes a first handle 10 and a second handle 101 pivoted together. In FIG. 4, the preferred embodiment for the first and the second handles 10, 101 is shown as a U-shaped long stem body in the sectional view, and the first handle 10 and the second handle 101 are oppositely assembled based on the opening of the U-shape. One end of the first handle 10 is a first fixation portion 11, another end thereof is a second fixation portion 13, and the middle thereof is a central portion 12. An axis-extended first pilot groove 121 is configured in the central portion 12, and the passing bores 122 are correspondingly configured upon the first pilot groove 121. An axis bore 103 is configured on the aforementioned second handle 101, and a pivot bore 102 is configured on one end 101A of the second handle 101. The pivot bore 102 and the passing bore 122 of the first handle 10 are pivoted with each other by the dowel. In addition, a positioning rod 16, a second pilot groove 14 along the long axis of the first handle 10, and an opening 15 are sequentially disposed on the first handle 10 and neighboring to the second fixation portion 13.

The lever gadget 20 includes a first lever 22 and a second lever 23. The first lever 22 is a rectangular body and has a bending section at its central portion. A pivot bore 222 is configured on the bending section, and the passing bores 221, 223 are configured on two ends (20A, 20C) of the first lever 22. Further, the second lever 23 is a rectangular body, and two passing bores 231, 232 are configured on two ends (20D, 20B) of the second lever 23. In the preferred embodiment, each of the first lever 22 and the second lever 23 is composed of two-piece body, wherein the two-piece body of the first lever 22 is assembled with the spacer, and the first lever 22 can be configured in the second handle 101. The passing bore 223 and the axis bore 103 of the second handle 101 are pivoted together with the dowel. Further, the two-piece body of the second lever 23 is designed as the spaced intervals at the position of the passing bore 232 and has a space within the intervals. One end 20D of the second lever 23 is inserted into the two-piece body of the first lever 22, and the passing bore 231 and the pivot bore 222 are pivoted together with a dowel.

The first cable-crimping gadget 10A includes a crimping and cutting element 30, a receptacle holder 40 and an assembling seat 50. The crimping and cutting element 30 is a block, which has one portion 35A designed for accommodating the connector 80A to be cable-crimped and has another portion 35B sequentially connected to a crimping and cutting seat 31, an adjustment element 32 and a connection rack 33. The crimping and cutting element 30 moreover can be configured in the first fixation portion 11 of the first handle 10. A slot 301 is formed beneath the crimping and cutting element 30. The crimping and cutting seat 31 is configured to accommodate the crimping and cutting element 30. The crimping and cutting seat 31 is a hollow frame 31B and protrudes two slice bodies 31C at two lateral sides, and a stopper 34 is disposed to engage the slot 301. The mounting elements are disposed on the frame 31B and corresponding to two lateral sides of the crimping and cutting element 30 so that the crimping and cutting element 30 is engaged with the crimping and cutting seat 31. The mounting element is practically designed as the tapped holes 311 passing through the frame 31B, and a screw 312 is screwed into the tapped holes 311 to engage the crimping and cutting element 30.

Furthermore, the adjustment element 32 is configured between the crimping and cutting seat 31 and the connection rack 33. One end of the adjustment element 32 is connected to the crimping and cutting seat 31, and another end thereof is configured as a screw rod (where the detail configuration is the prior art). The connection rack 33 is a U-shaped frame 33A which includes a bottom plate and two-side piece bodies 33B situated at the two sides of the bottom plate. A tapped hole 331 is configured on the bottom plate to provide the engagement with the screw rod of the connection rack 33, so as to provide the adjustable distance of the crimping and cutting element 30 relative to the connection rack 33. Two passing bores 332 are separately configured on two-side piece bodies 33B and face with each other. Two dowels 123 pass through the first pilot groove 121 and two passing bores 332 of the connection rack 33. Further, a positioning rod 16 is disposed on the first handle 10 and neighbors to the second fixation portion 13. An elastic element (or resistant element) 161 is disposed between the positioning rod 16 and the aforementioned dowel 123, so as to provide a power to move the crimping and cutting element 30 toward the second fixation portion 13.

The receptacle holder 40 is a block, in which a combination portion 41 is disposed at one end of the receptacle holder 40 and a chamber 42 is formed at another end thereof. The chamber 42 is accommodated for inserting and positioning the corresponding connector 80A.

The assembling seat 50 can be configured in the first fixation portion 11 of the first handle 10. The configuration is designed to configure several passing bores on the assembling seat 50 and the first fixation portion 11, and each passing bores are passed and fixed with the dowels. Further, a positioning slot 51 of the assembling seat 50 is formed corresponding to one portion 35A of the crimping and cutting element 30, and a recess 53 is formed at another portion thereof. The recess 53 accommodates for a connector 80A to crimp a cable 90A. The positioning slot 51 provides for the insertion and release of the combination portion 41 of the receptacle holder 40 at the vertical direction. The protruding bars at two sides of the combination portion 41 are engaged with the recess of the positioning slots 51. The passing tapped hole is configured at the assembling seat 50 corresponding to the positioning slot 51, and a screw is screwed into the receptacle holder 40. Further, the penetrated and hollow sliding grooves 52 which are extended along the long axis of the first handle 10 are formed on the two outside walls 54 of the assembling seat 50, and the sliding grooves 52 provide for the movement of the pair of rails 31A of the crimping and cutting seat 31 in the sliding grooves 52. Furthermore, a rod is disposed to connect the free ends 31D of the pair of rails 31A so that the crimping and cutting element 30 is stably and correspondingly moved toward the receptacle holder 40.

The second cable-crimping gadget 10B includes a press plate 60 and a socket 70, wherein one end of the press plate 60 is connected to the second end 61B of an actuation rack 61, and the actuation rack 61 has a two-space body 61E with two spacers (61F, 61G). The press plate 60 is disposed on the first outer surface 61H of the actuation rack 61. A short groove 611 and a passing bore 61C are configured on the body of the actuation rack 61 and along the long axis of the first handle 10. The short groove 611 at one end 61A of the actuation rack 61 are pivoted with the passing bore 232 of the second lever 23 by the dowel 612. Further, a passing bore is configured on the press plate 60 corresponding to the passing bore 61D of the actuation rack 61. A dowel 613 is pivoted with the passing bores 61D. The terminals of two dowels (junctions) 612, 613 are situated in the second pilot groove 14. In the embodiment shown in FIG. 2, a slice 601, disposed on the second outer surface 611 of the actuation rack 61, is configured at the actuation rack 61 and at another side of the press plate 60.

The socket 70 is a block which is configured on the first handle 10 and neighbors to the second fixation portion 13. A chamber 71 is formed at one end of the socket 70 at the axial direction and corresponding to the opening 15. The shape of the chamber 71 is designed to accommodate with the connector 80B to crimp a cable 90B. The lateral grooves 72 are formed at two lateral surfaces of the socket 70 along the long axis of the first handle 10. The lateral grooves 72 are interconnected with the chamber 71, and the press plate 60 and the slice 601 are situated in the lateral grooves 72. Several passing bores 73 are configured on the block and are distanced from the terminal of the lateral grooves 72, and the passing bores are pivoted with the passing bore disposed on the second fixation portion 13.

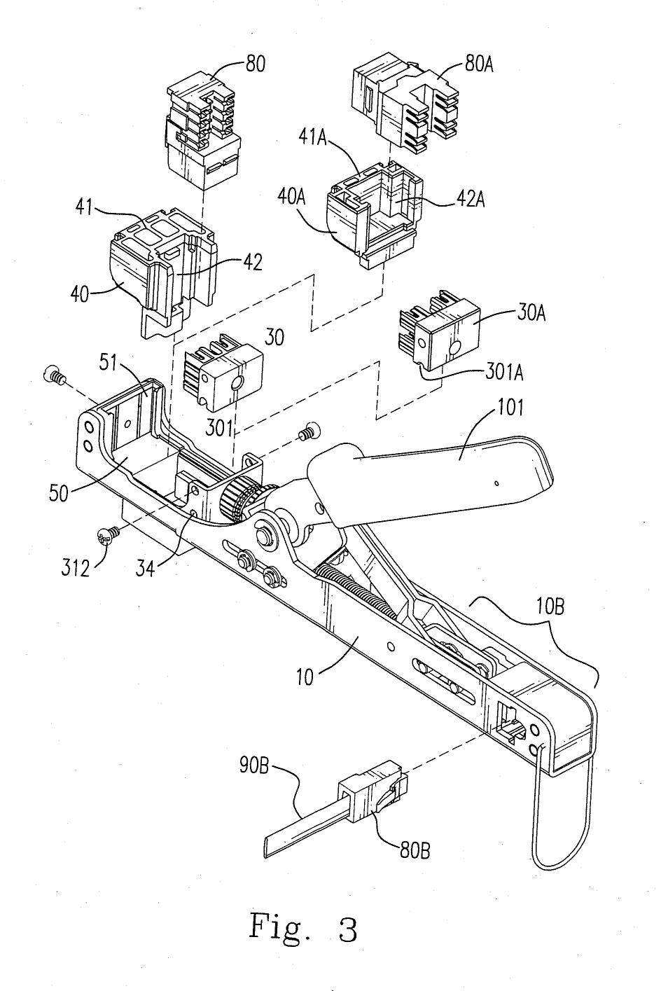

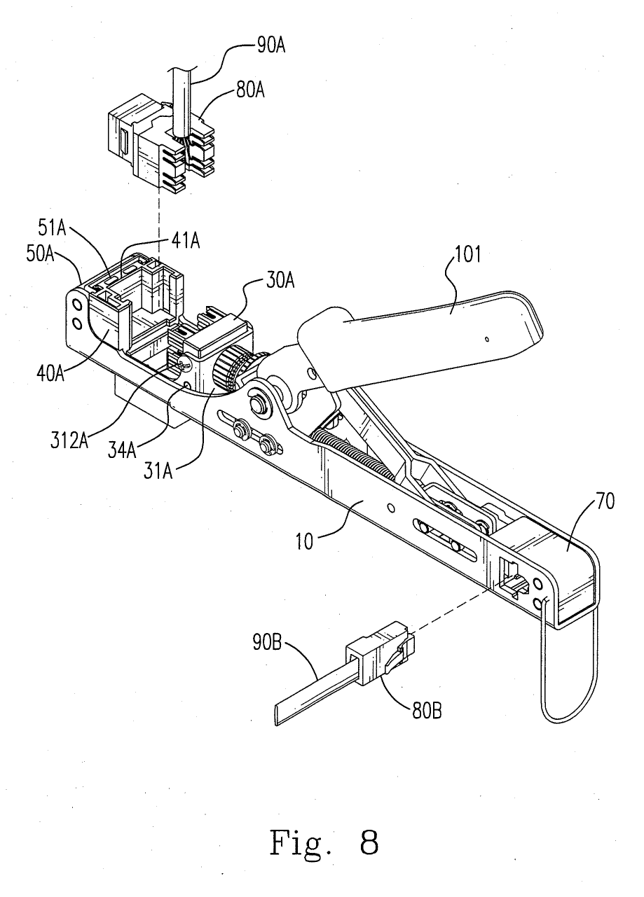

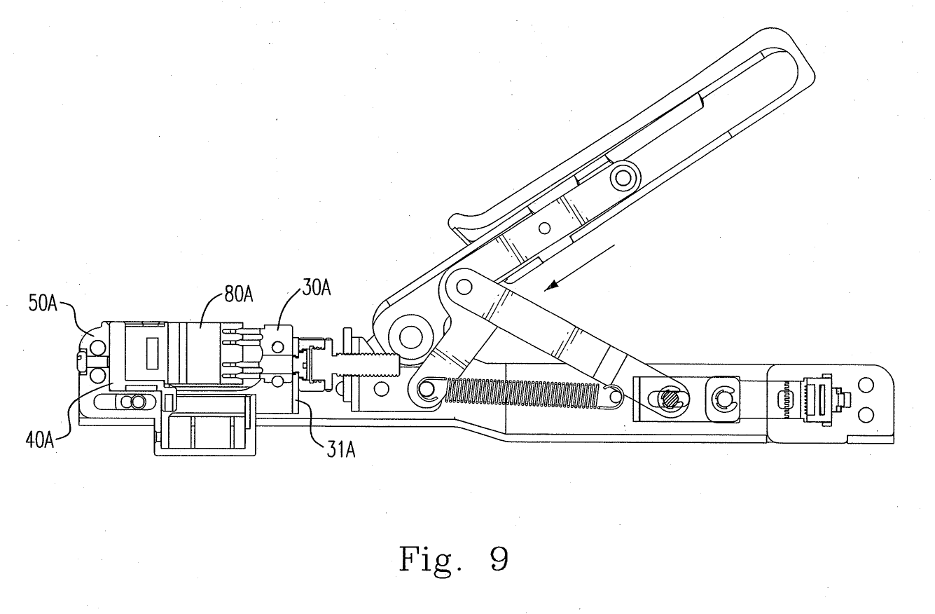

Please cooperatively refer to the two-in-one cable-crimping device of the present invention in FIGS. 3, 8 and 9, in addition to the receptacle holder 40 being disposed on the assembling seat 50, the chamber 42 of the receptacle holder 40 is provided for insertion of the connector 80. The cable 90A is crimped into the corresponding connector 80 in cooperation with the movable crimping and cutting element 30. Further, the present invention provides for the cable-crimping operation on the connector 80A with different specifications. The receptacle holder 40A accommodated with the connector 80A and the crimping and cutting element 30A is configured on the first handle 10. It is also suggested that the combination portion 41A of the receptacle holder 40A is engaged with the positioning slot 51A of the assembling seat 50, and the crimping and cutting element 30A is disposed in the crimping and cutting seat 31A, and the slot 301A of the crimping and cutting element 30A is engaged with the stopper 34A. Then, the screws 312A fasten the crimping and cutting element 30A and crimping and cutting seat 31A. Therefore, for the cable-crimping operation on various connectors (80A, 80B), it is simple and convenient to replace the cable-crimping components by using one hand tool and the other cooperated dies.

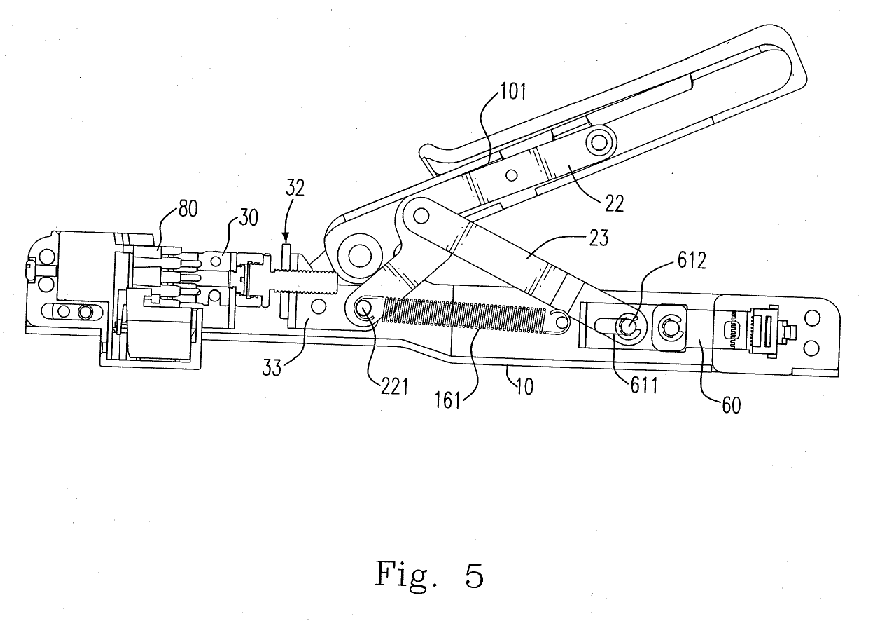

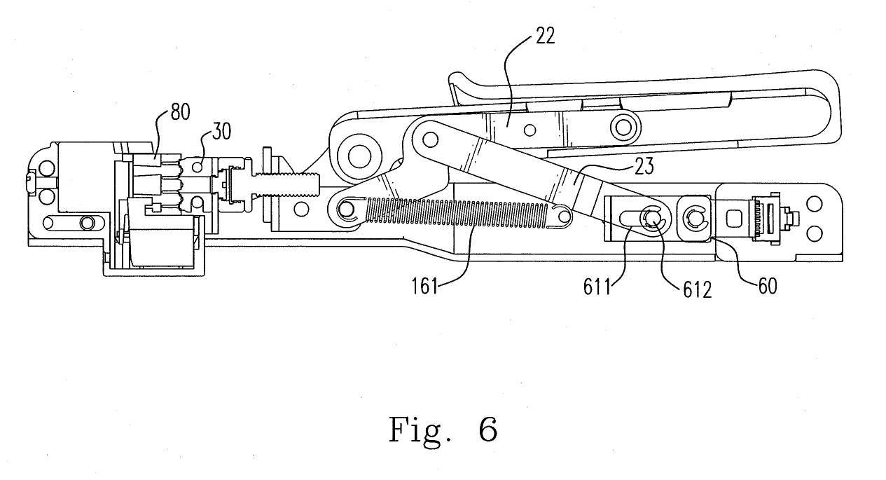

Please cooperatively refer to FIGS. 3, 4, 5 and 6, which are the cable-crimping operation on the connectors 80, 80B with different specifications in accordance with the preferred embodiment of the present invention. The receptacle holder 40 with a corresponding specification is configured in the assembling seat 50 of the first handle 10 for disposing the connector 80 into the receptacle holder 40. Another connector 80B is inserted into the chamber 71 of the socket 70 at the second fixation portion 13. When the second handle 101 is gripped corresponding to the first handle 10, as shown in FIGS. 5 and 6, the second terminal 20C of the first lever 22 which is actuated by the second handle 101 pushes the actuation rack 33 so as to move the crimping and cutting element 30 of the crimping and cutting seat 31 toward the connector 80. Further, by using the crimping and cutting element 30 engaged the connector 80, each cable 90A can be crimped into the connector 80.

Furthermore, when the second handle 101 is pressed, the second lever 23 is actuated to simultaneously move due to the first lever 22. The dowel 612 is removed from one end of the short groove 611 to the other end thereof due to the second lever 23. At this moment, the press plate 60 does not move corresponding to the socket 70. When the second lever 23 continues to move downward, the dowel 612 is engaged at the edge of the short groove 611 to drive the actuation rack 61 moved and to simultaneously drive the press plate 60 and the corresponding plate 601 moved, so that the cable 90B is crimped into the connector 80B. Since the route which the press plate 60 crimps into the connector 80B is shorter than that which the crimping and cutting element 30 crimps into the connector 80 through the first lever 22, the dowel 612 actuated by the second lever 23 is moved within the short groove 611 at the initial stage and do not push the press plate 60. Thus, when the second handle 101 is moved to the end point toward the first handle 10, the cable-crimping operation on the crimping and cutting element 30 to the connector 80 and the press plate 60 to the connector 80B, respectively, can be simultaneously accomplished (referring to FIG. 6).

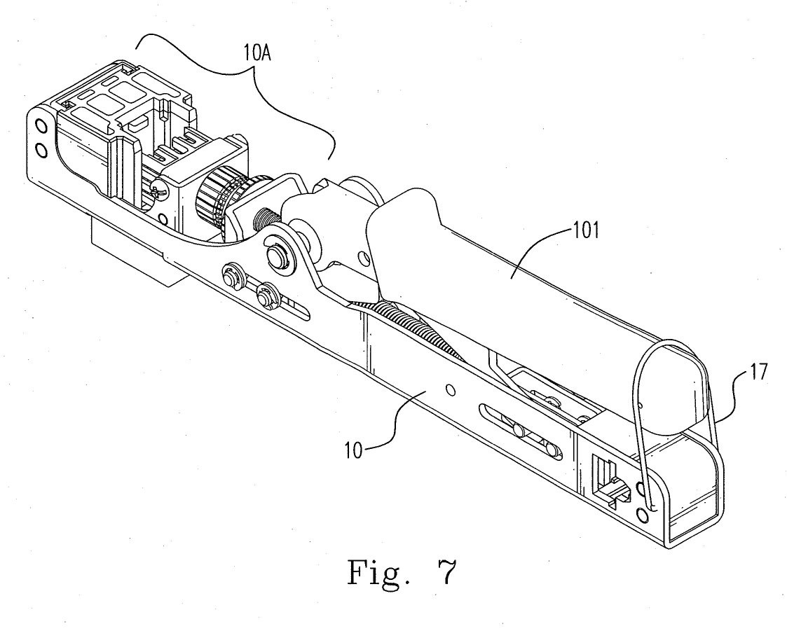

Please refer to FIGS. 2 and 7, when the cable-crimping device of the present invention is retrieved, the first and the second handles 10, 101 approach together, and the lock loop pivoted at the second fixation portion 13 of the first handle 10 is hooked on the terminal of the second handle 101, so as to reduce the distance between the first handle 10 and the second handle 101 and easily to be retrieved.

Please cooperatively refer to FIGS. 3, 8 and 9, which are the cable-crimping operation on the connector 80A according to the preferred embodiment of the present invention. First, the crimping and cutting element 30, unloaded by releasing the screw 312, is replaced by the crimping and cutting element 30A with the corresponding specifications of the connector 80A. The slot 301A at the bottom of the crimping and cutting element 30A is engaged with the stopper 34, and the crimping and cutting element 30A is fastened with the screw 312. The receptacle holder 40 is unloaded from the positioning slot 51 of the assembling seat 50, and is replaced as the receptacle holder 40A with the corresponding specifications of the connector 80A. The combination portion 41A of the receptacle holder 40A is engaged with the positioning slot 51, and the chamber 42A is provided to position the connector 80A. The cable-crimping operation can be performed in cooperation with the crimping and cutting element 30A, and it is simple and convenient to operate and replace the components with different specifications.

Although the cable-crimping operation can be performed on the different kinds of connectors (80, 80A, 80B), the same kind of connectors also would be acceptable.

While the invention has been described in terms of what is presently considered to be the most practical and preferred Embodiments, it is to be understood that the invention needs not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A two-in-one cable-crimping device for connectors, comprising:
a pair of handles having a first handle with a first fixation portion, a central portion and a second fixation portion and a second handle with an end pivoted at the central portion;
a first cable-crimping gadget configured at the first fixation portion;
a second cable-crimping gadget configured at the second fixation portion; and
a lever gadget configured at the second handle and having a first lever with a first terminal connected to the second handle and a second terminal connected to the first cable-crimping gadget and a second lever with a first end pivotally attached to the first lever and a second end connected to the second cable-crimping gadget,
wherein the first handle and the second handle are gripped together to simultaneously cause two cables to be crimped with the connectors respectively in the first and the second cable-crimping gadgets.

2. The two-in-one cable-crimping device according to claim 1, wherein the first cable-crimping gadget comprises:
a receptacle holder having a combination portion and having a chamber to insert a jack therein;
a crimping and cutting element having a first portion corresponding to the receptacle holder and a second portion pivotally configured to the second terminal of the first lever; and
an assembling seat disposed in the first fixation portion of the first handle and having a positioning slot engaging with the combination portion of the receptacle holder.

3. The two-in-one cable-crimping device according to claim 2, wherein the first cable-crimping gadget further comprises a crimping and cutting seat having a frame for disposing the crimping and cutting element therewithin, an adjustment element and a connection rack, and the crimping and cutting element comprises a slot therebeneath and is sequentially assembled with the crimping and cutting seat, the adjustment element and the connection rack.

4. The two-in-one cable-crimping device according to claim 3, wherein the frame comprises:
a two-piece body which has two pieces being correspondingly parallel with each other;
a stopper passing through the two-piece body to engage with the slot; and
two mounting elements disposed on the two-piece body to fix the crimping and cutting element and the crimping and cutting seat together.

5. The two-in-one cable-crimping device according to claim 3, wherein the connection rack comprises a U-shaped frame having a bottom plate and a two-side piece body having two side pieces being correspondingly parallel with each other, the bottom plate has a tapped hole to locate therein the adjustment element, the two-side piece body has at least one passing bore thereon, the first handle further comprises a first pilot groove corresponding to the at least one passing bore, and the first pilot groove, the at least one passing bore and the first lever are pivotally connected.

6. The two-in-one cable-crimping device according to claim 3, wherein the crimping and cutting seat comprises two slice bodies with two free ends and a rod, the assembling set has two side walls being parallel with each other and having two hollow sliding grooves introducing the two slice bodies to be moved therewithin, the rod is passing through the two hollow sliding grooves and connected to the two free ends to move the crimping and cutting element corresponding to the receptacle carrier, and the assembling seat further comprises a recess corresponding to the crimping and cutting element.

7. The two-in-one cable-crimping device according to claim 6 further comprising:
a positioning rod disposed at the first handle and neighboring to the second cable-crimping gadget;
an offset rod; and
an elastic element disposed between the positioning rod and the offset rod.

8. The two-in-one cable-crimping device according to claim 1, wherein the first handle further comprises a second pilot groove and an opening, and the second cable-crimping gadget further comprises:
an actuation rack comprising a first passing bore, a second passing bore, a short groove and a junction, and being pivoted to the second lever and the second pilot groove through the first passing bore;
a press plate pivoted to the junction of the actuation rack through the second passing bore; and
a socket configured in the second fixation portion, corresponding to the press plate, and having a chamber disposing therein one of the connectors.

9. The two-in-one cable-crimping device according to claim 8, wherein the second cable-crimping gadget further comprises a slice, the socket further comprises a lateral groove, the actuation rack further comprises a body with two spacers having a first outer surface and a second outer surface, the press plate is disposed on the first outer surface, and the slice is disposed on the second outer surface and movable in the lateral groove.

10. The two-in-one cable-crimping device according to claim 1, wherein each of the first fixation portion and the second fixation portion has a third passing bore to be pivoted to the respective first and the second cable-crimping gadgets.

11. The two-in-one cable-crimping device according to claim 1, wherein the connectors are the same kind of connectors.

12. The two-in-one cable-crimping device according to claim 1, wherein the connectors are different kinds of connectors.

13. A cable-crimping device, comprising:
a first cable-crimping gadget;
a second cable-crimping gadget;
a first lever having a first terminal pivotally connected to the first cable-crimping gadget and a second terminal; and
a second lever having a third terminal pivotally connected to the second terminal of the first lever and a fourth terminal pivotally connected to the second cable-crimping gadget.

14. The cable-crimping device according to claim 13 further comprising:
a first handle having a first fixation portion, a central portion coupled to the first terminal, and a second fixation portion; and
a second handle configured to cover the first lever,
wherein the first cable-crimping gadget is configured on the first fixation portion and the second cable-crimping gadget is configured on the second fixation portion.

15. The cable-crimping device according to claim 14, wherein the first cable-crimping gadget comprises:
an assembling seat having a pair of grooves and disposed on the first fixation portion;
a receptacle holder disposed on the assembling seat;
a crimping and cutting seat having a pair of rails respectively sliding on the pair of grooves; and
a crimping and cutting element configured on the crimping and cutting seat,
wherein a first connector and a cable are disposed in a space between the receptacle holder and the crimping and cutting element, and the crimping and cutting element is moved forward to the receptacle holder to press the cable into the first connector.

16. The cable-crimping device according to claim 15, wherein the first cable-crimping gadget further comprises:
a connector rack having a body and two arms connected to the first lever; and
an adjustment connected between the body of the connector rack and the crimping and cutting seat.

17. The cable-crimping device according to claim 14, wherein the second cable-crimping gadget comprises:
a socket having a chamber and disposed on the second fixation portion;
a linker having a first end being pivotally connected to the second lever and a second end; and
a press plate connected between the second end of the linker and the socket,
wherein a second connector and a cable are disposed in the chamber, and the press plate is moved forward to the socket to press the cable into the second connector.

18. The cable-crimping device according to claim 14, wherein the first handle has a positioning rod, the cable-crimping device further comprises an resilient element connected between the first lever and the positioning rod.

19. A cable-crimping device, comprising:
a first cable-crimping gadget;
a second cable-crimping gadget; and
a lever gadget having at least having a first terminal being pivotally connected to the first cable-crimping gadget and a second terminal being pivotally connected to the second cable-crimping gadget.

20. The cable-crimping device according to claim 19 further comprising:
a first handle having a first fixation portion, a central portion, a second fixation portion and a positioning rod;
a second handle having a first end pivotally connected to the central portion; and
an elastic element elastically connected between the first cable-crimping gadget and the positioning rod,
wherein the lever gadget further comprises a third terminal being pivotally connected to the second handle, the first cable-crimping gadget is disposed in the first fixation portion, the second cable-crimping gadget is disposed in the second fixation portion, and the first terminal is pivotally connected to the second handle.
